(19) United States
(12) Patent Application Publication
(10) Pub. No.: US 2016/0349998 A1
(43) Pub. Date: Dec. 1, 2016

(54) Storage Control Block Administration

(71) Applicant: International Business Machines Corporation, Armonk, NY (US)

(72) Inventors: Philip R. Chauvet, Tucson, AZ (US); Franklin E. McCune, Tucson, AZ (US); David C. Reed, Tucson, AZ (US); Max D. Smith, Tucson, AZ (US)

(21) Appl. No.: 14/725,124

(22) Filed: May 29, 2015

(51) Int. Cl. G06F 3/06

(52) U.S. Cl. CPC G06F 3/064; G06F 3/0604; G06F 3/0653; G06F 3/0673

(57) ABSTRACT

A method, system and computer readable medium for managing and profiling control blocks via a storage control block administration operation. More specifically, in certain embodiments, the control block administration operation includes identifying areas of storage that are currently being used by storage control blocks. When the areas of storage being used by the control blocks are identified, the control blocks are profiled. In certain embodiments, the profiles enable limits and recovery actions to be specified by the control block administration operation.

### BACKGROUND OF THE INVENTION

Field of the Invention

The present invention relates in general to the field of computer operations and, more particularly to administration of storage control blocks.

Description of the Related Art

It is known to control storage systems using powerful host computer systems such as mainframe type computer systems. These host systems execute operating systems such as the z/OS operating system available from IBM. The z/OS operating system is well suited for continuation, high volume operation with high security and stability.

One issue encountered on operating systems such as the z/OS operating system relates to managing control blocks. In the z/OS operating system, a control block is a block of memory containing information. Often an application executing on the z/OS operating system creates and maintains one or more control blocks. Managing control blocks can be an issue because often large numbers of control blocks can be created depending on program activity and the type of control block. Also, control blocks can vary widely. Some control blocks are small, others are very large. Some control blocks reside in private storage, others reside in common storage.

However, under certain circumstances, the storage used by control blocks can have an impact on performance of the system including possibly exhausting available system storage. For example, when an error event or events or unusually high activity takes place, the storage used by these control blocks can exhaust system storage. Also, recovery activities for these control blocks if often handled differently if the storage is obtained in common or private storage. When common memory is inadvertently left without being freed, the storage remains orphaned until the system is reinitialized, via e.g., an initial program load (IPL). Unlike private storage, storage obtained in the common region can be used by multiple address spaces, and is not automatically freed when the program ends.

Accordingly, it would be desirable to provide a straightforward method for managing and profiling control blocks.

### SUMMARY OF THE INVENTION

In accordance with the present invention, a method, system and computer readable medium are provided for managing and profiling control blocks via a storage control block administration operation. More specifically, in certain embodiments, the control block administration operation includes identifying areas of storage that are currently being used by storage control blocks. When the areas of storage being used by the control blocks are identified, the control blocks are profiled. In certain embodiments, the profiles enable limits and recovery actions to be specified by the control block administration operation.

More specifically, in certain embodiments, the invention relates to a method for administering control blocks, the method comprising: identifying areas of storage that are currently being used as control blocks; profiling the control blocks to provide control block profile information; storing at least some of the control block profile information in a storage location remote from the control blocks; and, administering the control blocks using the control block profile information.

In certain embodiments, the invention relates to a system comprising: a processor; a data bus coupled to the processor; and a computer-usable medium embodying computer program code, the computer-usable medium being coupled to the data bus. The computer program code comprising instructions executable by the processor and configured for: identifying areas of storage that are currently being used as control blocks; profiling the control blocks to provide control block profile information; storing at least some of the control block profile information in a storage location remote from the control blocks; and, administering the control blocks using the control block profile information.

In certain embodiments, the invention relates to a computer-usable medium embodying computer program code, the computer program code comprising computer executable instructions configured for: identifying areas of storage that are currently being used as control blocks; profiling the control blocks to provide control block profile information; storing at least some of the control block profile information in a storage location remote from the control blocks; and, administering the control blocks using the control block profile information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram showing a host computer in communication with a data storage system.

FIG. 2 is a block diagram showing a host computer communication path manager.

FIG. 3 shows a flow chart of the operation of an orphan storage recovery operation.

### DETAILED DESCRIPTION

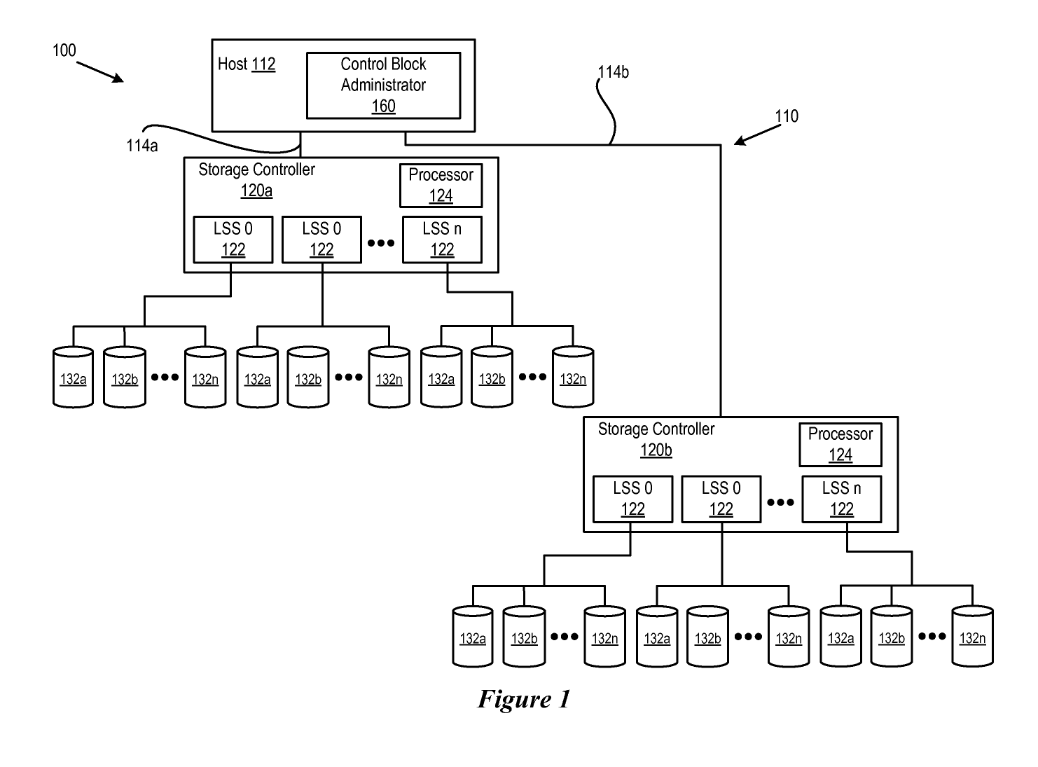

Referring to FIG. 1, a data processing system 100 comprises data storage system 110 and one or more host computers 112 (also referred to as hosts). The storage system 110 is in communication with host computer 112 via communication paths 114a, 114b. Communication paths 114a, 114b each comprise a communication link, where that communication link can be configured to comprise up to 256 logical pathways. The illustrated embodiment shows a single host computer. In other embodiments, data storage system 110 may be in communication with a plurality of host computers.

Although the system is described in terms of a storage control unit or “controller” and logical storage subsystems (LSS), the system may be implemented with other devices as well. The storage system 110 includes a storage system such as those available from International Business Machines under the trade designation IBM DS6000 or DS8000. In certain embodiments, the storage system 110 includes two storage controllers 120a and 120b, storage devices 132, such as hard disk drivers (HDDs). In certain embodiments, the storage system can further include an interface, such as an IBM Enterprise Storage Server Network Interface (ESSNI) or other interface.

The host 112 is coupled to the storage controller via appropriate connections through which commands, queries, response and other information are exchanged. The storage controller 120 may be configured with one or more logical storage subsystems (LSSs) 122 (e.g., LSS 0, LSS 1, . . . LSS n). Each LSS is assigned one or more storage devices 132.

The host computer 112 includes provision for execution of a control block administration module 160. The control block administration module 160 enables a host 112 to manage and profile control blocks via a storage control block administration operation. The control block administration module 160 includes, or has access to, a control block administration information data repository 162. In various embodiments, the control block administration module 160 includes a control block profiler.

More specifically, in certain embodiments, the control block administration operation includes identifying areas of storage that are currently being used by storage control blocks. When the areas of storage being used by the control blocks are identified, the control blocks are profiled. In certain embodiments, the profiles enable limits and recovery actions to be specified by the control block administration operation. For example, even though a particular control block may be in common storage, if that address space or task that owns that storage goes away, the control block administration operation provides functionality to free that storage if the profile for that control block indicates it should be handled in that manner. As another example, if automatic recovery of a control block is not requested, the control block administration operation conducts logging of abnormalities or operator alerts.

The control block administration module 160 monitors the first use of storage after it is obtained, e.g., via storage controller 120. If the storage is used for a control block, the control block administration module 160 associates a unique identifier, often referred to as an eye catcher, with the control block. Additionally, when the storage is identified as a control block, the control block administration module 160 determines a type of the control block and establishes properties to be monitored based upon the type of control block. The properties for control blocks to be monitored by the control block administration module 160 are stored in control block administration data structure such as the control block administration information data repository 162.

In various embodiments, the control block properties include one or more of a control block unique identifier length indicator, a location of the unique identifier of the control block, an identification of the unique identifier, secondary identifying characteristic of the control block if available, a control block length indicator of each control block, an indication of a limit to a total number of allowable control blocks of a particular type, control section (CSECT) names indicating a location from which the storage for control block is obtained, information regarding common storage task termination handling for the control block. When a control block is identified as a control block to be monitored, several options are available for affecting how that storage is to be used.

For example, with control blocks that are located within common storage of the data storage system 110, when a storage area is identified as containing a control block that should be freed from common when an operation associated with the control block is terminated, the control block administration module 160 frees the storage associated with the control block when the operation associated with the control block is terminated. This operation is based upon the information regarding common storage task termination handling for the control block associated with the control block and stored within the control block administration data structure.

Also for example, with control blocks that are located within private storage of the data storage system 110, when a storage area is identified as containing a control block that should not be freed when an operation associated with the control block is terminated, the control block administration module 160 maintains the storage associated with the control block when the location of an operation associated with the control block is terminated. This operation is based upon the information regarding common storage task termination handling for the control block associated with the control block and stored within the control block administration data structure. Accordingly, further to this example, this allows those areas of storage designed to be left for other address space usage to remain without being freed as compared with known systems where during task termination, the private memory owned by that task goes away as the address space goes away. For those areas of storage where the information regarding common storage task termination handling for the control block indicates to maintain the control block, the control block is not be freed. This allows those areas of storage designed to be left for other address space usage to remain without being freed.

Additionally, the control block profiler allows the areas of storage to be handled differently based on the type of control block held in that storage. The handling of the control block does not have to be set in the program that initially builds or obtains the storage for the control block. Providing the control block administration operation with profiler functionality also allows the control block handling to be changed at any time by adjusting the settings within the control block administration data structure.

Additionally, the control block profiler allows actions to be taken when a control block exceeds certain thresholds. For example, if a particular type control block generally has less than 5000 control blocks in existence on the system at any one time, if this threshold is exceeded actions can be taken. For example, certain messages can start to be issued to the host 112. This can allow automation to take steps based on these messages. In certain extreme cases such as where run away storage usage appears to be related to a loop or other type of program error or where system resource shortages may lead to a system outage, the address space creating these storage areas may be reported to a client to take action or the host may automatically take remedial action. In certain cases, the user may select to have an out of control address space automatically cancelled based on this control block creation indication.

Additionally, logging of such events can be used for analysis by application owners. This analysis may be used as a debugging tool. For example, the control block profiler can monitor what is referencing the particular storage and even what is updating it. Detecting updates to such control blocks from applications that are not typical users of the control block can aide in storage overlay analysis, a problem that can be prevalent in common storage and difficult to resolve.

Additionally, the control block profiler can be used is as a system health indicator. For example if a system is having performance issue or storage shortages, particular control blocks may have a different usage pattern. By identifying how these control block attributes relate to overall system health, other health checking functions can also be provided through the control block profiler. For example, when opening a virtual storage access method (VSAM) data set if certain error conditions occur, the VSAM data set often attempts to obtain storage to verify that the data set being opened is not damaged and is valid. In doing this, the VSAM data set obtains control blocks which are identified by the control block administration module 160. Depending on the type of data set and the type of open (e.g., VSAM keyed sequence data set (KSDS) vs integrated catalog forward (ICF) Catalog for the type of data set and global shared resources (GSR) vs non-shared resources (NSR) for the open), the VSAM data set may obtain the storage in private or common storage. If the verify process does not complete successfully, this process may be repeated which can exhaust storage either private or common storage. While a restart of the address space would free any private storage, the common storage would not be freed. With the control block administration operation, the common storage could be freed to avoid system outages.

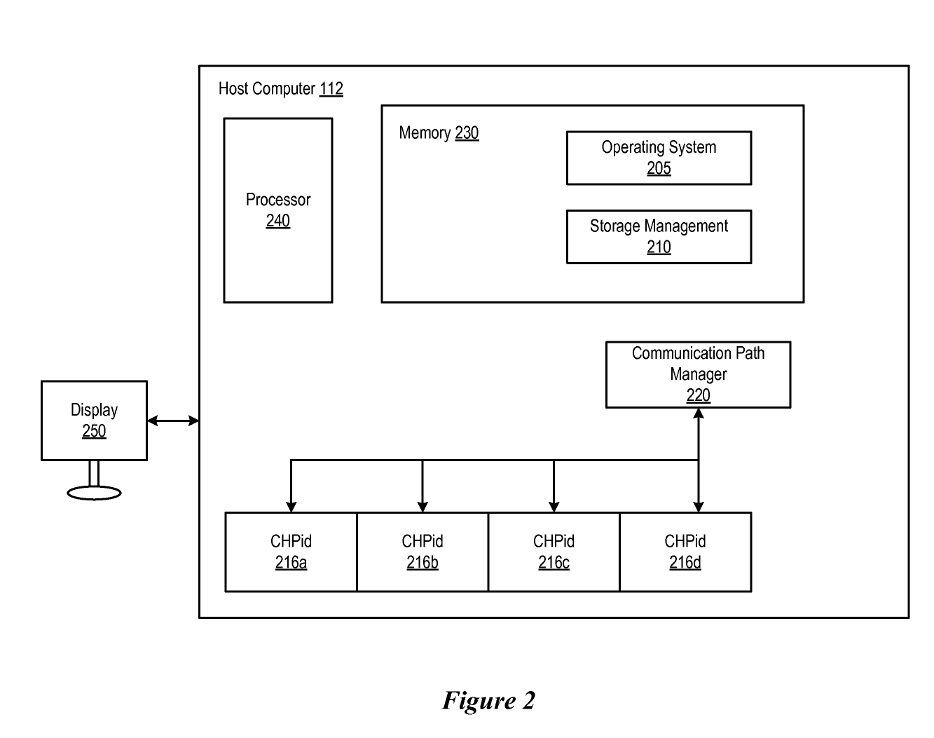

Referring to FIG. 2, the host computer 112 comprises a computer system, such as a mainframe, personal computer, workstation, and combinations thereof, including an operating system 205 such as z/OS, Windows, AIX, Unix, MVS, LINUX, etc. (Windows is a registered trademark of Microsoft Corporation; z/OS and AIX are registered trademarks and MVS is a trademark of IBM Corporation; and UNIX is a registered trademark in the United States and other countries licensed exclusively through The Open Group.) The host computer 112 can further include a storage management program 210. The storage management program in the host computer 112 may include the functionality of storage management type programs known in the art that manage the transfer of data to a data storage and retrieval system, such as the IBM DFSMS implemented in the IBM MVS operating system. The storage management program may also include the storage block administration functionality.

The host computer 112 can also comprise a plurality of channel path identifiers (“CHPids”) (e.g., CHPids 216a, 216b, 216c, 216d). CHPids 216a, 216b, 216c, 216d, are physically interconnected to respective host adapters within the storage controller 120. The host computer 112 further comprises a communication path manager 220, where the communication path manager 220 is in communication with each of CHPids 216. In certain embodiments, the communication path manager 220 configures each of communication paths, to comprise up to 256 logical communication pathways.

The host computer 112 further comprises a memory 230 (e.g., a computer readable medium). The operating system 205 and the storage management program 210, are stored on the memory 230. The operating system 205 and the storage management program 210 include instructions which may be loaded on and executed by a processor 240. The host computer 112 may be interconnected with display device 250. The display device 250 may be integral with host computer 112 or may be remote from host computer 112. For example, the display device 250 may be located in a system administrator's office.

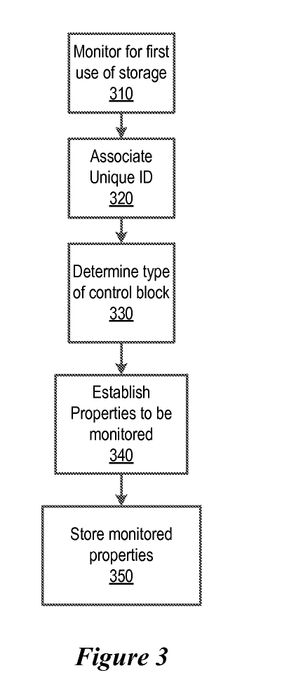

Referring to FIG. 3, a flow chart of a control block administration operation 300 is shown. In various embodiments, the control block administration operation 300 is provided by a program (e.g., the control block administration module 160) which is external to the operating system 205 or is incorporated into the operating system 205.

More specifically, at step 310, the control block administration module 160 monitors the first use of storage after the storage is obtained, e.g., via storage controller 120. If the storage is used for a control block, then at step 320 the control block administration module 160 associates a unique identifier, often referred to as an eye catcher, with the control block. Next, at step 330 when the storage is identified as a control block, the control block administration module 160 determines a type of the control block. At step 340, the control block administration module 160 establishes properties to be monitored based upon the type of control block. Next, at step 350 the properties for control blocks to be monitored by the control block administration module 160 are stored in control block administration data structure such as the control block administration information data repository 162.

In various embodiments, the control block properties include one or more of a control block unique identifier length indicator, a location of the unique identifier of the control block, an identification of the unique identifier, secondary identifying characteristic of the control block if available, a control block length indicator of each control block, an indication of a limit to a total number of allowable control blocks of a particular type, control section (CSECT) names indicating a location from which the storage for control block is obtained, information regarding common storage task termination handling for the control block.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present invention has been described in detail, it should be understood that various changes, substitutions and alterations can be made hereto without departing from the spirit and scope of the invention as defined by the appended claims.

What is claimed is:

1. A method for administering control blocks, the method comprising:
identifying areas of storage that are currently being used as control blocks;
profiling the control blocks to provide control block profile information;
storing at least some of the control block profile information in a storage location remote from the control blocks; and,
administering the control blocks using the control block profile information.

2. The method of claim 1, wherein:
the profiling further comprises associating a unique identifier with each control block.

3. The method of claim 1, wherein:
the profiling further comprises determining a type of the control block; and further comprising
establishing control block properties to be monitored based upon the type of control block.

4. The method of claim 3, further comprising:
storing the control block properties for control blocks to be monitored within a control block administration data structure.

5. The method of claim 1, further comprising:
when an area of storage is identified as a control block to be monitored, the administering comprises a plurality of possible options affecting how the area of storage is to be used.

6. The method of claim 1, wherein:
the control block information includes at least one of a control block unique identifier length indicator, a location of the unique identifier of the control block, an identification of the unique identifier, secondary identifying characteristic of the control block if available, a control block length indicator of each control block, an indication of a limit to a total number of allowable control blocks of a particular type, control section (CSECT) names indicating a location from which the storage for control block is obtained, information regarding common storage task termination handling for the control block.

7. A system comprising:
a processor;
a data bus coupled to the processor; and
a computer-usable medium embodying computer program code, the computer-usable medium being coupled to the data bus, the computer program code comprising instructions executable by the processor and configured for:
identifying areas of storage that are currently being used as control blocks;
profiling the control blocks to provide control block profile information;
storing at least some of the control block profile information in a storage location remote from the control blocks; and,
administering the control blocks using the control block profile information.

8. The system of claim 7, wherein:
the profiling further comprises associating a unique identifier with each control block.

9. The system of claim 7, wherein:
the profiling further comprises determining a type of the control block; and the computer program code further comprises instructions executable by the processor and configured for:
establishing properties to be monitored based upon the type of control block.

10. The system of claim 9, wherein the computer program code further comprises instructions executable by the processor and configured for:
storing the properties for control blocks to be monitored within a control block administration data structure.

11. The system of claim 7, wherein the computer program code further comprises instructions executable by the processor and configured for:
when an area of storage is identified as a control block to be monitored, the administering comprises a plurality of possible options affecting how the area of storage is to be used.

12. The system of claim 7, wherein:
the control block information includes at least one of a control block unique identifier length indicator, a location of the unique identifier of the control block, an identification of the unique identifier, secondary identifying characteristic of the control block if available, a control block length indicator of each control block, an indication of a limit to a total number of allowable control blocks of a particular type, control section (CSECT) names indicating a location from which the storage for control block is obtained, information regarding common storage task termination handling for the control block.

13. A computer-usable medium embodying computer program code, the computer program code comprising computer executable instructions configured for:
identifying areas of storage that are currently being used as control blocks;
profiling the control blocks to provide control block profile information;
storing at least some of the control block profile information in a storage location remote from the control blocks; and,
administering the control blocks using the control block profile information.

14. The computer-usable medium of claim 13, wherein:
the profiling further comprises associating a unique identifier with each control block.

15. The computer-usable medium of claim 13, wherein:
the profiling further comprises determining a type of the control block; and the computer program code further comprises instructions executable by the processor and configured for:
establishing properties to be monitored based upon the type of control block.

16. The computer-usable medium of claim 15, wherein the computer program code further comprises instructions executable by the processor and configured for:
storing the properties for control blocks to be monitored within a control block administration data structure.

17. The computer-usable medium of claim 13, wherein the computer program code further comprises instructions executable by the processor and configured for:
when an area of storage is identified as a control block to be monitored, the administering comprises a plurality of possible options affecting how the area of storage is to be used.

18. The computer-usable medium of claim 13, wherein:
the control block information includes at least one of a control block unique identifier length indicator, a location of the unique identifier of the control block, an identification of the unique identifier, secondary identifying characteristic of the control block if available, a control block length indicator of each control block, an indication of a limit to a total number of allowable control blocks of a particular type, control section (CSECT) names indicating a location from which the storage for control block is obtained, information regarding common storage task termination handling for the control block.
